(19) United States
(12) Patent Application Publication
(10) Pub. No.: US 2012/0136696 A1
(43) Pub. Date: May 31, 2012

(54) Method for the Simultaneous Diffusion of Survey Questionnaires on a Network of Affiliated Websites

(75) Inventors: Frank Smadja, Haifa (IL); Frédéric-Charles Petit, Brussels (BE)

(73) Assignee: TOLUNA, Levaliois-Perret (FR)

(21) Appl. No.: 13/364,397

(22) Filed: Feb. 2, 2012

Related U.S. Application Data
(63) Continuation of application No. 12/256,884, filed on Oct. 23, 2008.

(30) Foreign Application Priority Data
Jan. 23, 2008 (FR) 08 00357

(51) Int. Cl. G06Q 30/02

(52) U.S. Cl. 705/7.32

(57) ABSTRACT

The method according to the invention consists of dynamically adapting survey questionnaires to the content of the affiliated Web sites of editors and the specific visitors of said sites. It comprises the dynamic selection of the most appropriate questionnaire for a given survey in function of the content of the site of the editor and/or the specific who visits the Web site of the editor and/or the response rate to the questionnaire.

### CROSS-REFERENCE TO RELATED APPLICATIONS

The present application is a continuation application and claims priority benefit to a co-pending non-provisional application entitled “Method for the Simultaneous Diffusion of Survey Questionnaires on a Network of Affiliated Web Sites,” which was filed on Oct. 23, 2008 and assigned Ser. No. 12/256,884.

### BACKGROUND OF THE INVENTION

### Field of the Invention

This invention relates to a method for the simultaneous diffusion of survey questionnaires on a network of affiliated Web sites.

It concerns the field of on-line targeted announcements and, but not exclusively, applies to a particular type of announcements that can be used to carry out market surveys.

This type of announcement will be designated hereafter by the terms “survey questionnaires”. In its broadest sense and in the context of this application, a survey should be considered to be means which permit the opinions of a large number of on-line users to be collected. It may be presented in the form of a standard questionnaire wherein the users have to choose between several possible answers. However, it may also be designed so that it simply permits a user to give his/her opinion, knowledge, evaluation, etc. on any determined subject.

In its most general form, the survey questionnaire may consist of a announcement banner displayed on the screen and inviting the user to click on a sub-zone of the screen.

The owner of the Internet site or Blog on which the survey questionnaire is displayed is called the “editor”. The entity that wishes to carry out the market study is called “the advertiser” and the system which distributes or publishes simultaneously the survey questionnaires to the editors is called the “survey network”.

The invention is based on the idea that to provide a high CPM rate (cost per click, cost per thousand) for a simultaneous diffusion of survey questionnaires, these questionnaires must be of interest to the user answering the survey.

In the context of an affiliated network, the invention considers that the only way to achieve this result is by means of very dynamic adaptation of the survey questionnaire to the content of the editor and the specific visitor of site of the editor.

Consequently, for example, a survey questionnaire asking questions on the subject of driving preferences has a greater probability of obtaining a response if it is situated in a Blog concerning cars, and a very low probability of obtaining a response if it is situated in a Blog concerning animations.

### SUMMARY OF THE INVENTION

The invention permits this result to be obtained by means of a very dynamic selection method that selects the most appropriate questionnaire, for example the questionnaire with the highest hierarchical rating for a given survey based on the following elements:

The content of the Web site of the editor: this requires a dynamic reaction especially in the case of Blogs that may add new content several times a day.

The content of the survey questionnaires.

The specific user who visits the Web site of the editor if this user has already received a message (cookie) from the survey network.

The background of the user on the survey network: other survey questionnaires that have been answered, unanswered questionnaires, basic demographic information, interests, etc.

The response (click) rate: a survey questionnaire that does not get enough “clicks” is probably a survey questionnaire that is not correctly positioned. The invention proposes therefore to adapt the hierarchical rating in function of the validation (click) rate.

### BRIEF DESCRIPTION OF THE DRAWINGS

One application mode of the invention is described below, by way of non-restrictive example, in reference to the appended drawings in which:

FIG. 1 is a diagrammatical representation of a survey network;

FIG. 2 is a block diagram which illustrates the process of supplying a survey questionnaire whose rating is dynamically optimised.

### DESCRIPTION OF THE PREFERRED EMBODIMENTS

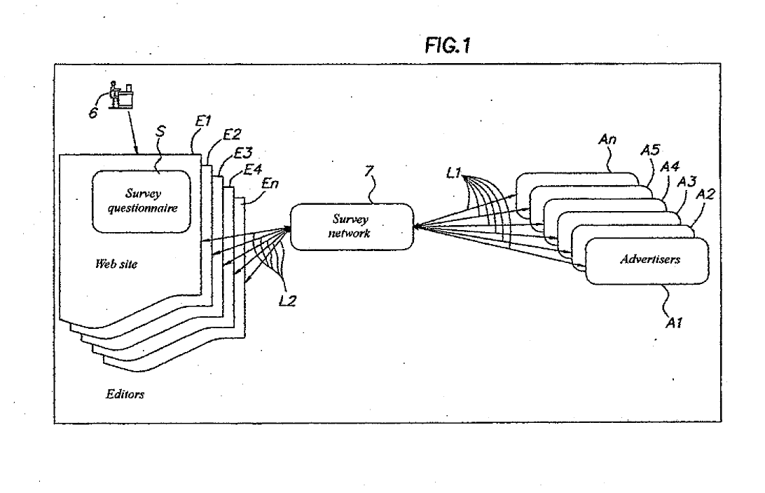

In the example shown in FIG. 1, the method according to the invention involves a plurality of Web sites E₁, E₂, E₃, E₄ . . . Eₙ each belonging to an editor. On each of these sites E₁, E₂, E₃, E₄ . . . E. may be displayed a survey questionnaire S that is accessible by a user 6 who has a computer system (processor/keyboard/screen) connected to the network. The survey questionnaires S are distributed on the sites E₁, E₂, E₃, E₄ . . . Eₙ means of a survey network 7, initiated by a plurality of advertisers A₁, A₂, A₃, A₄, A₅, Aₙ who wish to carry out market surveys.

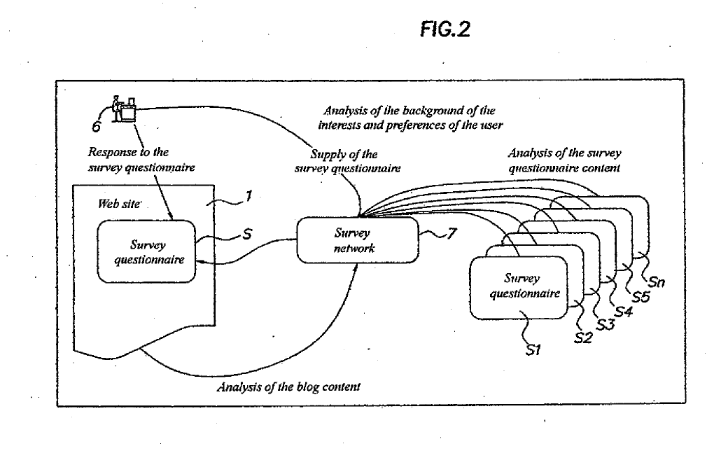

As illustrated in FIG. 2, the survey network 7 is designed so as:

To analyse the content of the survey questionnaires S₁, S₂, S₃, S₄, S₅, Sₙ issued by the advertisers A₁, A₂, A₃, A₄, A₅, Aₙ (L₁ connections),

To analyse the content of the Blogs of the editors (L₂ connections),

To analyse the background of the user 6, the behaviour and preferences of the latter, and

To provide the Web sites E₁, E₂, E₃, E₄ . . . Eₙ of the editors a survey questionnaire that is dynamically optimised in function of the results of said analyses.

This solution especially permits a higher CPM rate (cost per click, cost per thousand) to be obtained, especially thanks to:

More appropriate linking between the interests of the user and the content of the survey questionnaire displayed by the editor,

Totally dynamic hierarchical rating that is adapted to the new content,

Totally dynamic hierarchical rating that is adapted to the flow or the response (click) rate.

The method described above may be implemented as follows:

The entity that is interested by a market survey pays to place survey questionnaires.

The editors concerned then supply the survey network with free space on their respective Web sites E₁, E₂ . . . Eₙ or their Blogs.

The survey network 7 will then place the survey questionnaires on the free spaces of the sites of the editors E₁, E₂ . . . Eₙ by using the hierarchical rating process described above.

One application mode of the hierarchical rating process is described below:

Initially, a clustering algorithm is used, such as the K-means method, the EM algorithm or the main component analysis to distribute the editors in function of the content of their sites E₁, E₂ . . . Eₙ. This “clustering” may use the content of the sites E₁, E₂ . . . Eₙ as well as meta-information in the form of notes, anchor texts and cross references.

Hierarchical rating is used for the questionnaires S₁, S₂ . . . Sₙ for each cluster and the best survey questionnaires are determined for each cluster.

The hierarchical rating is adapted for each pair [survey questionnaire/site] based on the response rate (click rate) to the questionnaire on the specific site.

The hierarchical rating is finally adapted for each pair [visitor, questionnaire] in function of the background of the user with the survey network.

1. A method for diffusing a survey questionnaire on a Web site, said method comprising:
hierarchically rating a plurality of survey questionnaires to provide to a user on a Web site, wherein the plurality of survey questionnaires are hierarchically rated based on previously answered survey questionnaires and previously unanswered survey questionnaires by the user;
selecting a survey questionnaire, wherein the survey questionnaire is the survey questionnaire with the highest hierarchical rating; and
diffusing the survey questionnaire to the user on the Web site, wherein the survey questionnaire is diffused to the user on the Web site by means of a survey network, and wherein the diffusing step is computer-implemented.

2. The method according to claim 1, wherein the plurality of survey questionnaires are hierarchically rated based on the content of the Web site.

3. The method according to claim 2, wherein because the plurality of survey questionnaires are hierarchically rated based on the content of the Web site, there is a higher probability of obtaining a response from the user to the survey questionnaire.

4. The method according to claim 1, wherein the plurality of survey questionnaires are hierarchically rated based on the content of the plurality of survey questionnaires.

5. The method according to claim 1, wherein the plurality of survey questionnaires are hierarchically rated based on whether the user has received a message from the survey network.

6. The method according to claim 1, wherein the plurality of survey questionnaires are hierarchically rated based on a background of the user.

7. The method according to claim 6, wherein the background of the user comprises at least one of demographic information, interests, behavior and preferences of the user.

8. The method according to claim 1, wherein the plurality of survey questionnaires are hierarchically rated based on a response rate to the plurality of survey questionnaires.

9. The method according to claim 1, wherein the Web site belongs to an editor.

10. The method according to claim 1, wherein the survey questionnaire form consists of an announcement zone that is displayed on a screen and which invites the user to click on a sub-zone of the screen.

11. The method according to claim 1, wherein the survey questionnaire is displayed on the initiative of a plurality of advertisers desiring to carry out market surveys.

12. The method according to claim 1, further comprising placing the survey questionnaire on a free space of the Web site.

13. The method according to claim 1, wherein hierarchically rating comprises
creating at least one cluster of a plurality of editors, wherein the at least one cluster is based on the content of the Web site of the plurality of editors; and
hierarchically rating the plurality of survey questionnaires for the at least one cluster.

14. A system for diffusing a survey questionnaire on a Web site, said system comprising:
a server hosting a Web site, said server being configured to diffuse a plurality of survey questionnaires on the Web site,
wherein the plurality of survey questionnaires are hierarchically rated based on previously answered survey questionnaires and previously unanswered survey questionnaires by a user,
wherein the server is further configured to diffuse to the user viewing the Web site a survey questionnaire with the highest hierarchical rating, and
wherein the survey questionnaire is accessible by the user viewing the Web site via a computer.

15. A system of carrying out market surveys, the system comprising a survey network providing communication between one or more Web sites and one or more advertisers;
whereby a plurality of survey questionnaires are hierarchically rated based on previously answered survey questionnaires and previously unanswered survey questionnaires by a user, and
whereby one of the advertisers diffuses a survey questionnaire with the highest hierarchical rating to the user on a Web site, wherein the survey questionnaire is accessible by the user on a Web site via a computer.
